(19) United States
(12) Patent Application Publication
(10) Pub. No.: US 2012/0097285 A1
(43) Pub. Date: Apr. 26, 2012

(54) PIPE CLAMP

(76) Inventor: Luke Spencer Thomas, Western Cape (ZA)

(21) Appl. No.: 13/220,269

(22) Filed: Aug. 29, 2011

(30) Foreign Application Priority Data
Aug. 27, 2010 (ZA) 2010/06133

(51) Int. Cl. F16L 3/00

(52) U.S. Cl. 138/106

(57) ABSTRACT

This invention relates to a pipe clamp, and more particularly, but not exclusively, to a pipe repair clamp suitable for use in sealing holes or cracks in walls of pipes. The pipe clamp comprises a clamping band and two clamping elements. Each clamping element includes an elongate body having a groove provided in a side thereof for receiving an end of the clamping band, with the elongate body also having a receiving aperture for receiving a fastener provided therethrough, the receiving aperture being substantially perpendicular relative to the groove. The clamping element is characterized in that the groove and the receiving aperture at least partially coincide, in order for the receiving aperture to extend at least partially through the groove.

### BACKGROUND TO THE INVENTION

THIS invention relates to a pipe clamp, and more particularly, but not exclusively, to a pipe repair clamp suitable for use in sealing holes or cracks in walls of pipes.

Clamps for repairing fluid conveyance pipelines are well known in the art. A pipe repair clamp of the type with which this invention is concerned consists essentially of a sheet metal band which encapsulates the pipe to be repaired. This band has opposing free ends, each of which is anchored to a clamping element. Bolts pass through aligned openings in respective lugs of the clamping elements, and when nuts of the bolts are tightened the two ends of the metal sheet are urged towards one another.

A gasket of rubber or another suitable elastomer material is provided on the inner side of the metal band, and is therefore sandwiched between the metal band and the wall of the pipe being repaired. A tapered zone is typically provided at each end of the rubber seal so as to allow the two ends to overlap when the clamp is installed. The clamping elements constrict the metal sheet around the rigid pipe, and effectively compress the gasket into a fluid tight engagement with the pipe surface thereby sealing any leak in the pipe.

Pipe repair clamps of the type described above are manufactured in various sizes to fit corresponding sized pipes.

Various methods of fastening the pipe repair clamp are available on the market today. The most common is a welded configuration of stainless steel clamping elements welded to opposing ends of the metal clamp band. When the nuts are tightened the two ends of the band are pulled together thus tightening the clamp. Another method includes two metal clamping elements that each include a receiving slot or groove in a leading edge thereof, in order for the slots or grooves to oppose one another when the clamping elements are assembled. Folded or suitably formed ends of the metal band are then slid into the grooves, with the configuration being such that they cannot be displaced from the groove in a direction perpendicular to the groove, thus enabling the clamping elements to exert a tensile force on the metal band when the clamping elements are displaced toward one another. A problem associated with this configuration is that the clamping bands are still longitudinally displaceable, and can therefore be displaced from the slots prior to or during installation.

It has in the past also been proposed to manufacture polymeric equivalents of the stainless steel components, but to date this approach has proven unsuccessful due to the excessive moment induced about the receiving lugs of the clamping members, thus causing the clamping elements to fail. This is especially problematic in the weakened zone adjacent the receiving slots or grooves, where a large moment is induced in existing clamping configurations.

It is accordingly an object of the invention to provide a pipe clamp that will, at least partially, alleviate the above disadvantages.

It is also an object of the invention to provide a pipe clamp which will be a useful alternative to existing pipe clamps.

It is furthermore an object of the invention to provide a clamping element for a pipe clamp that will, at least partially, alleviate the above disadvantages.

It is also an object of the invention to provide a clamping element for a pipe clamp which will be a useful alternative to existing clamping elements.

### SUMMARY OF THE INVENTION

According to a first aspect of the invention there is provided a clamping element, suitable for use in a pipe clamp, the clamping element including:
an elongate body having a groove provided in a side thereof, and having a receiving aperture for receiving a fastening means provided therethrough, the receiving aperture being substantially perpendicular relative to the groove;
characterized in that the groove and the receiving aperture at least partially coincides, in order for the receiving aperture to extend at least partially through the groove.

A zone of reduced thickness is defined in the body due to the presence of the groove, and the receiving aperture extends at least partially through the zone of reduced thickness, in order to in use minimize a moment induced about the zone of reduced thickness.

There is provided for a centerline of the groove and a centerline of the receiving aperture to be substantially in the same plane.

In a first embodiment of the clamping element the receiving aperture may be in the form of an open channel formed in the body.

In a second embodiment of the clamping element the receiving aperture may be in the form of an enclosed bore provided through the body, in order for the receiving aperture to be enclosed. In this embodiment there is also provided for an operatively upper sidewall of the receiving aperture to be reinforced.

Preferably a clamping element of the first embodiment is used in combination with a clamping element of the second embodiment so as to form a clamping element set.

There is still further provided for cantilevered supporting arms to extend from the body.

The clamping element is preferably made from a polymeric material.

According to a further aspect of the invention there is provided a pipe clamp including at least one clamping element as described above.

There is provided for the pipe clamp to include a sheet metal band having ends that are adapted to be complementary to grooves provided in the clamping elements.

Apertures are provided in the ends of the sheet metal, the apertures in use aligning with receiving apertures in the clamping element in order to prevent sideways displacement of the ends of the band relative to the clamping elements once bolts have been installed through the receiving apertures of the clamping elements.

### BRIEF DESCRIPTION OF THE DRAWINGS

A preferred embodiment of the invention is described by way of a non-limiting example, and with reference to the accompanying drawings in which:

FIG. 1 is a perspective view of a pipe clamp in accordance with the invention, including two clamping elements in accordance with the invention;

FIG. 2 is a perspective view of a clamping element set in accordance with the invention, showing a first clamping element and a second clamping element;

FIG. 3 is a side view of the first clamping element of FIG. 2; and

FIG. 4 is a side view of the second clamping element of FIG. 2.

### DETAILED DESCRIPTION OF INVENTION

Referring to the drawings, in which like numerals indicate like features, a non-limiting example of a pipe clamp in accordance with the invention is generally indicated by reference numeral 10.

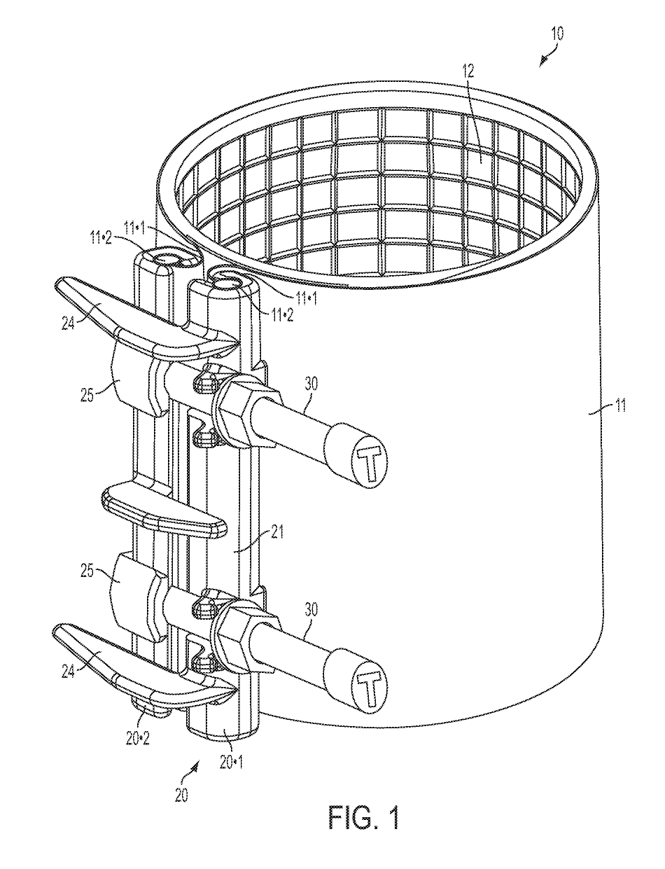

Referring to FIG. 1, the pipe clamp 10 comprises a flexible band 11 made from a suitable material, and in particular is generally in the form of a sheet metal band. The band 11 has two opposing ends 11.1 which are located adjacent one another when the band 11 is located about the circumference of a pipe to be sealed. A sealing element 12, which may take many different forms, is located between the band 11 and the pipe, and when a closing force is imparted on the band (as is described in more detail below) the sealing element 12 is forced against the outer wall of the pipe, and in particular over an opening in the wall of the pipe that requires sealing. The ends 11.1 of the band terminates in engagement formations 11.2 suitable for engaging clamping elements 20 that are in use used to urge the two ends 11.1 towards one another, thus causing the band to contract and to sandwich the sealing element 12 between the pipe and the band 11. The engagement formations may be formed in various ways, including repeatedly bending the ends into a suitable configuration, and/or inserting an insert at or in the end of the band.

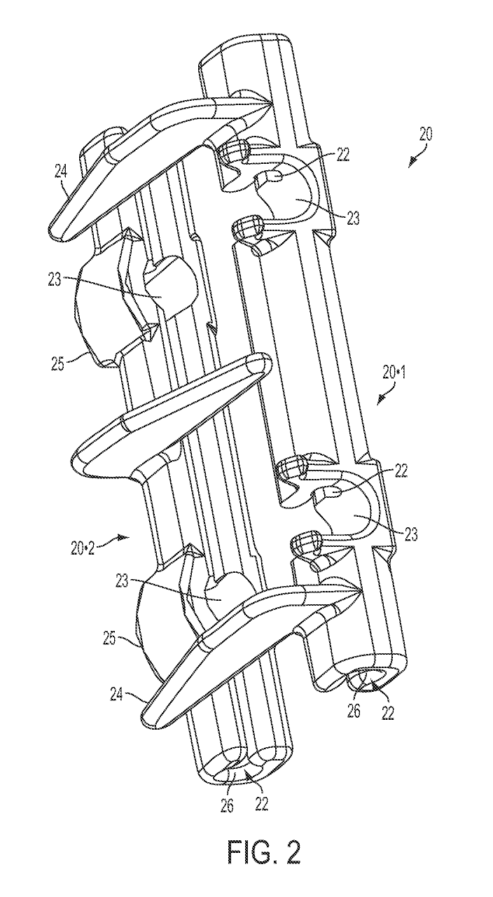

The clamping elements 20 of this particular embodiment are now described with reference to FIGS. 2 to 4. A clamping set 20 comprises two clamping elements (20.1 and 20.2) which are in use located parallel to one another, and which are linked by way of a bolting arrangement 30 (FIG. 1), which is also used to urge the two clamping elements (20.1 and 20.2) and thus the ends 11.1 of the metal band 11, towards one another. In this particular embodiment the two clamping elements (20.1 and 20.2) are of different shape and configuration, but it should be understood that they can also be substantially identical.

Each clamping element (20.1 and 20.2) comprises an elongate body 21 having a longitudinal groove 22 provided in a side thereof. The groove 22 is configured and dimensioned to be complementary to the engagement formations 12 on the metal band 11. The engagement formations 12 are secured to the clamping elements (20.1 and 20.2) by sliding each engagement formation 12 into a groove 22 along a longitudinal axis of the groove 22. The configuration of the groove is however such that the engagement formations 12, once inserted into the grooves 22, cannot be displaced perpendicularly relative to the grooves 22, thus allowing a force exerted on the clamping elements (20.1 and 20.2) to be transmitted to the engagement formations 12, and thus the ends 11.1 of the metal band 11. It should be noted that the provision of the grooves 22 in the elongate body 21 results in a zone of reduced thickness 26 being formed in the body 21 adjacent the grooves 22. These zones are particularly vulnerable to failure, especially if a moment is induced about said zones.

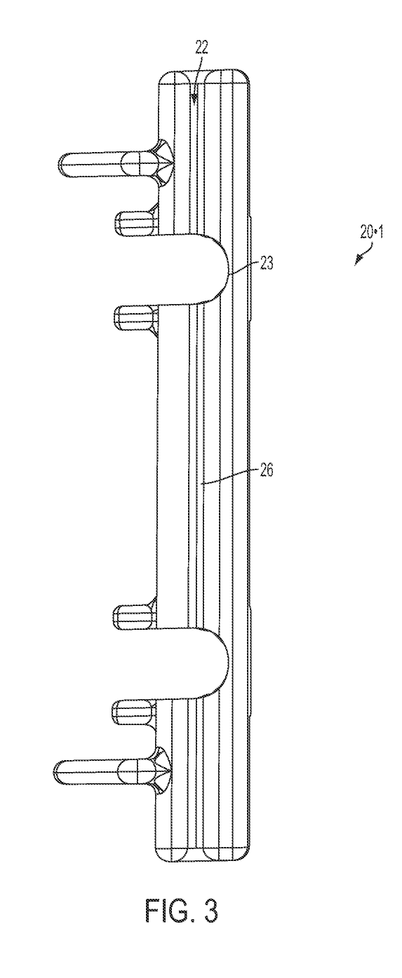

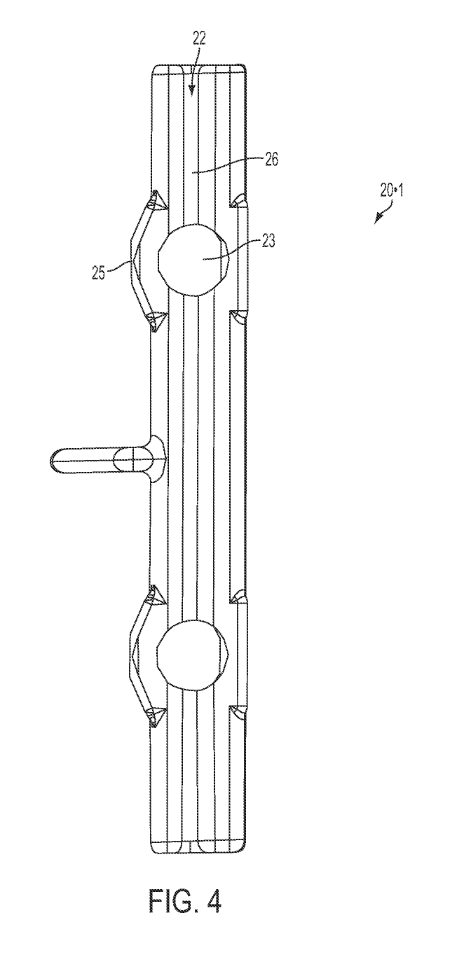

The clamping elements (20.1 and 20.2) also include receiving apertures 23 for receiving bolts of the bolting arrangement 30. These receiving apertures are substantially perpendicular relative to the grooves 22 and, significantly (as is best seen in FIGS. 3 and 4), at least partially coincides with the grooves 22—i.e. at least part of each groove 22 and receiving aperture 23 overlie one another. This is an important aspect of this invention, as it results in the bolt exerting a compressive force on the clamping element, but without imparting a substantial moment about the zone of reduced thickness 26, which would have for example been the case if the receiving apertures were in the form of receiving formations provided on an upper surface of the body 21 of the clamping element. The moment is therefore reduced by reducing the distance between the force imparted by the bolt on the body, and the oppositely directed forced imparted by the end of the band onto the body. In addition, once the bolts are installed, they will extend through complementary slots (not shown) provided in the engagement formations 12, thus also preventing sideways displacement of the engagement formations 12 relative to the grooves 22.

It will be appreciated that there will be a tendency for the clamping elements (20.1 and 20.2) to flex inwardly when a clamping force is exerted thereon. For this reason countermeasures are provided to counteract this induced displacement. In this embodiment, the first clamping element 20.1 includes cantilevered supporting fingers 24 extending therefrom, and which in use abuts an upper surface of the body 21 of the opposing second clamping element 20.2. The receiving apertures 23 of the second clamping element 20.2 in turn is covered by a reinforced zone 25, thus allowing the bolt in use to abut the reinforced zone, in so doing preventing displacement of the second clamping element 20.2 relative to the bolt. It will however be appreciated that the second clamping element may also include supporting fingers, and that the first damping element may likewise include reinforced receiving apertures.

The inventor believes that this configuration, and in particular the orientation of the receiving apertures relative to the grooves, will inter alia alleviate the occurrence of failure of the clamping elements at the zones of reduced thickness, and will also be useful in that it will prevent the engagement formations from sliding out from the grooves when the clamp is being installed, and also once the clamp has been installed.

It will be appreciated that the above is only one embodiment of the invention and that there may be many variations without departing from the spirit and/or the scope of the invention.

1. A clamping element, suitable for use in a pipe clamp comprising two clamping elements and a clamping band, the clamping element including:
an elongate body having a groove provided in a side thereof for receiving an end of the clamping band, and
the elongate body having a receiving aperture for receiving a fastener provided therethrough, the receiving aperture being substantially perpendicular relative to the groove;
wherein the groove and the receiving aperture at least partially coincide, in order for the receiving aperture to extend at least partially through the groove.

2. The clamping element of claim 1 in which a zone of reduced thickness is defined in the body due to the presence of the groove, and the receiving aperture extends at least partially through the zone of reduced thickness.

3. The clamping element of claim 1 in which a centerline of the groove and a centerline of the receiving aperture are substantially in the same plane.

4. The clamping element of claim 1 in which the receiving aperture is in the form of an open channel formed in the body.

5. The clamping element of claim 1 in which the receiving aperture is in the form of an enclosed bore provided through the body, in order for the receiving aperture to be enclosed.

6. The clamping element of claim 5 in which an operatively upper sidewall of the receiving aperture is reinforced.

7. The clamping element of claim 4 in which at least one cantilevered supporting arm extends from the body.

8. The clamping element of claim 1 in which the elongate body is made from a polymeric material.

9. A pipe clamp including two clamping elements according to claim 1, and a sheet metal clamping band.

10. The pipe clamp of claim 9 including a one clamping element in which the receiving aperture is in the form of an open channel formed in the body and one clamping element in which the receiving aperture is in the form of an enclosed bore provided through the body, in order for the receiving aperture to be enclosed.

11. The pipe clamp of claim 9 in which ends of the sheet metal clamping band are complementary formed to grooves provided in the clamping elements.

12. The pipe clamp of claim 11 in which slots are provided in the ends of the sheet metal, the slots in use aligning with receiving apertures in the clamping element in order to prevent sideways displacement of the ends of the clamping band relative to the clamping elements once bolts have been installed through the receiving apertures of the clamping elements and through the slots in the ends of the sheet metal.
